(19) United States
(12) Patent Application Publication
(10) Pub. No.: US 2015/0009084 A1
(43) Pub. Date: Jan. 8, 2015

(54) ELECTROMAGNETIC BAND GAP DEVICE

(71) Applicant: THALES, Paris (FR)

(72) Inventors: Yonnec'h Coupa, Brest (FR); Michel Jousset, Brest (FR); Stephane Mallegol, Brest (FR)

(21) Appl. No.: 14/380,706

(22) PCT Filed: Feb. 19, 2013
(86) PCT No.: PCT/EP2013/053297

§ 371 Date: Aug. 22, 2014

(30) Foreign Application Priority Data
Feb. 23, 2012 (FR) 1200528

(51) Int. Cl. H01Q 15/14; H01Q 9/06; G06F 17/50; H01Q 19/10

(52) U.S. Cl. CPC H01Q 15/14; H01Q 19/10; H01Q 9/065; G06F 17/5081; G06F 17/5072
USPC 343/818; 343/913; 716/133

(57) ABSTRACT

An electromagnetic band gap device is disclosed that includes a dielectric support of which one face is metallized and of which a second face includes a plurality of non-adjoining conducting elements. Several conducting elements are linked together pairwise by a resistive element in the electromagnetic band gap device. At least two of the conducting elements are electrically insulated from one another and at least two resistive elements exhibit a different resistance value.

The present invention relates to the field of very wideband telecommunication systems. It relates more particularly to an electromagnetic band gap device, its use in an antenna device and a method for determining the parameters of said antenna device.

From a theoretical point of view, a planar wire antenna possesses a symmetric structure and radiates in a bidirectional manner in the two directions orthogonal to the plane of the antenna.

Generally, this bidirectional radiation is not truly of interest. Moreover, employing antennas installed on a platform, such as an aircraft for example, generally necessitates radiations directed toward the exterior of the platform; those directed toward the interior would not be of any interest with regard to receiving or transmitting outside the platform. Thus, this type of antenna is generally placed on a metallized support, to render it unidirectional.

A problem with this support is that it disturbs the antenna's aft radiation. Moreover, it generates reflections which may be destructive for the fore radiation, the integrity of which it is desired to safeguard. Finally, the support may also induce surface currents and itself generate parasitic radiation, thus reducing the operating frequency band.

An ideal support ought not to disturb the fore radiation, that is to say that directed toward the exterior of the platform, over the most extensive frequency band, and not generate parasitic radiation by induction. It would also exhibit minimum mass and bulk. Moreover, the radiating element associated with the support would exhibit the highest possible gain.

The use of a support comprising an absorbent cavity to remove a part of the aft radiation of the antenna and safeguard the latter's wideband behavior is known in the prior art. This cavity is generally produced with an absorbing material produced on the basis, for example, of a foam that is loaded with carbon or with iron powder. The aim of this absorbent material is to maximize the absorption of the aft radiation of the antenna and therefore to minimize the radiation reflected on the support so as to prevent the reflected wave, phase shifted relative to the wave radiated forwards, from disturbing the radiation of the antenna.

However, the absorbent materials used to remove the aft radiation exhibit certain drawbacks. The absorbent properties of a material depending on the frequency of the radiation, the aft radiation cannot be absorbed over wide frequency bands. The electromagnetic characteristics such as the permittivity and the permeability of the absorbents vary from one fabrication to another causing a dispersion in the antenna's radiated performance. The weight and the bulk of the absorbent materials rapidly increase as the frequency of the radiation to be absorbed decreases, correspondingly increasing the weight and the bulk of the support of the antenna. Finally, the whole of the aft radiation being unutilized, the losses at the level of the gain, which are related to the absence of reflected power, are significant (at the maximum 3 dB).

Another solution is aimed at maximizing the effect of the reflection of the aft radiation, by ensuring that the reflected electromagnetic wave is in phase with the incident wave. Accordingly, an electrical conducting plane having optimal reflection properties is disposed at a distance from the radiating element equal to a quarter of the wavelength of the radiation that the antenna device transmits or receives. Indeed, for this distance, the reflected aft radiation is in phase with the fore radiation. The effect of this is to maximize the power restored by the antenna.

The principal drawback of this solution is that the distance cannot be tailored in an optimal manner other than for a single wavelength. The radiation transmitted or received at wavelengths far from this central wavelength is disturbed, limiting, thereby, the bandwidth of the antenna. Another drawback of this solution is that a quarter of the wavelength rapidly represents a significant distance for low frequencies, thus giving rise to a relatively significant overall thickness for the antenna device. Furthermore, the conducting plane has significant induction properties, and reflection and diffraction phenomena occur at the edge of the antenna, thus generating parasitic radiations.

The use of an antenna reflector of EBG (Electromagnetic Band Gap) type is also known, notably through patent applications WO 2004/093 244, US 2002/167 457 and FR 2 916 308 as well as through the publications by GAO Q ET AL: “Application of metamaterials to ultra-thin radar absorbing material design” and by SCHREIDER L ET AL: “Broadband Archimedean spiral antenna above a loaded electromagnetic band gap substrate”.

Such a structure makes it possible to control the aft radiation so as to circumvent the parasitic radiations to which it gives rise. It may exhibit one of the following three properties:
Reflect the aft radiation of the radiating element in phase with the fore radiation.
Absorb the aft radiation.
Depending on the antenna's operating frequency band, absorb or reflect the aft radiation of the radiating element in phase with the fore radiation.

This structure is placed between the radiating element and its support. The lower face of the structure is composed of a ground plane on which rests a dielectric material which supports a periodic array of metallic conducting elements known as patches. Currently in the scientific literature the radiating element rests on an array of conducting elements which covers a larger surface area than the radiating element itself. Now, the dielectric substrate must exhibit a surface area at least equivalent to that of the array of patches of the electromagnetic band gap structure in order to be able to support it. For antennas working at low-frequency, such as for example around some hundred Megahertz, this condition necessitates producing electromagnetic band gap structures which exhibit high bulk and high mass.

Depending on the applications, the patches may be linked to the ground plane by way of through conductors or vias. In this case, the operating frequency band of the antenna is limited.

A structure in which the contiguous conducting elements of the array are linked pairwise by way of resistors is also known. One then speaks of LEBG for Loaded Electromagnetic BandGap. This latter type of wideband structure does not exhibit results that are completely satisfactory in terms of electromagnetic performance. The trend of the radiation patterns is degraded at the end of the operating band of the antenna. Indeed, this type of structure generates, for high frequencies, the appearance of sidelobes whose level may be greater than the principal lobe. This is also manifested by a decrease in the half-power aperture of the principal lobe. Moreover, for a given dielectric thickness, the gain in the radioelectric axis of the antenna is not optimal with respect to the expected theoretical gain. Indeed, the aft radiation of the antenna is not reflected in phase with the fore radiation whereas this condition is required for an optimal gain.

An aim of the invention is notably to correct the aforementioned drawbacks. For this purpose, the subject of the invention is an electromagnetic band gap device comprising a dielectric support of which one face is metallized and whose second face comprises a plurality of non-adjoining conducting elements. In this device, several conducting elements are linked together pairwise by a resistive element, at least two conducting elements are electrically insulated from one another, at least two resistive elements exhibit a different resistance value and at least two contiguous conducting elements are spaced apart by a distance d₁ and at least two contiguous conducting elements are spaced apart by a distance d₂, the distances d₁ and d₂ being different.

According to another particular feature at least two conducting elements exhibit different shapes.

According to another particular feature, at least two conducting elements occupy a different surface area.

According to another particular feature, at least one conducting element has a square shape.

According to another particular feature, at least one conducting element has a rectangular shape.

The subject of the invention is also the use of the device cited above in an antenna device, said antenna device comprising an assembly comprising at least one radiating element disposed opposite the face of the support of the electromagnetic band gap device comprising the conducting elements, this assembly comprising at least one radiating element being electrically insulated from said electromagnetic band gap device.

According to a particular feature, the assembly comprising at least one radiating element comprises at least one planar wire antenna.

According to another particular feature, the assembly comprising at least one radiating element is separated from the conducting elements by a dielectric substrate.

According to another particular feature, the projection in the plane containing the plurality of conducting elements of at least one radiating element exceeds the surface area occupied by the entirety of the conducting elements of the electromagnetic band gap device.

A third object of the invention is to propose a method for determining the parameters of the antenna device. This method comprises:
a step of determining the parameters of an elementary pattern,
a step of simulating an electromagnetic band gap device produced on the basis of the elementary pattern,
a step of optimizing the electromagnetic band gap device,
a step of optimizing the elementary patterns,
a step of optimizing the resistive elements.

In an advantageous manner, the present invention makes it possible to reduce the bulk and the mass of the band gap structure. The advantage of the invention is also to make it possible to improve the radiated electromagnetic performance of the antenna devices over a wide band of frequencies.

Other particular features and advantages of the present invention will be more clearly apparent on reading the description hereinafter, given by way of nonlimiting illustration, and with reference to the appended drawings, in which:

FIG. 1 represents an exemplary embodiment of an electromagnetic band gap device according to the prior art,

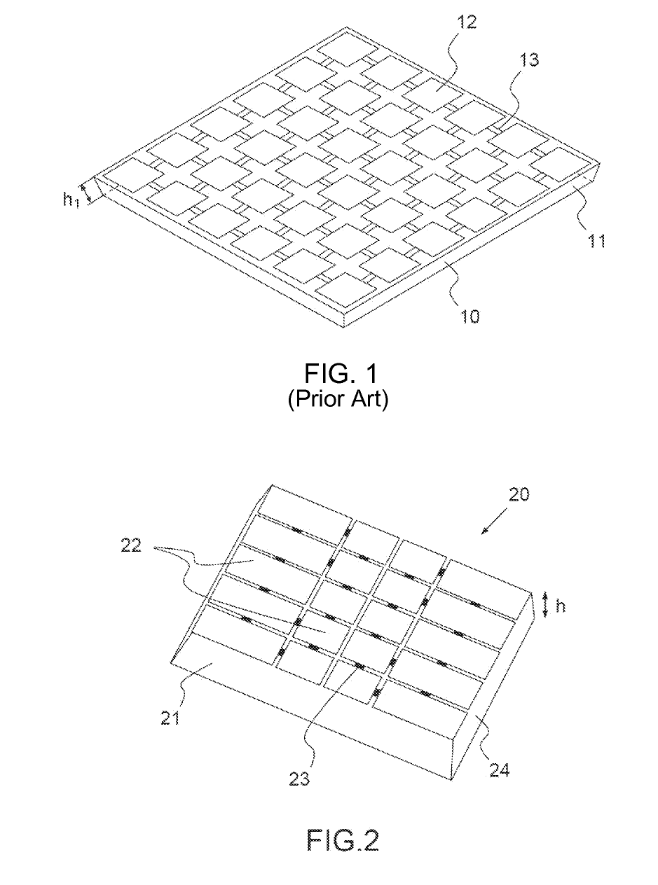

FIG. 2 represents an exemplary embodiment of an electromagnetic band gap device according to the invention,

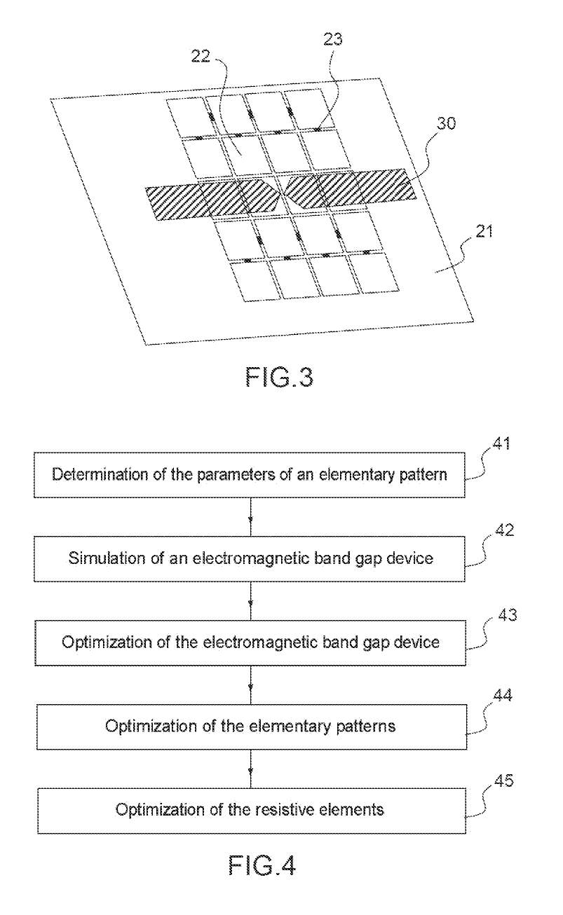

FIG. 3 represents an exemplary embodiment of an antenna device according to the invention.

FIG. 1 represents an exemplary embodiment of an Electromagnetic Band Gap (EBG) device known from the prior art. This device comprises a plane support 10 of dielectric material of height h₁. A face 11 of this support 10 is entirely metallized so as to form a ground plane. On the second face is disposed an array of non-adjoining identical conducting elements 12 disposed in a regular manner in rows and columns. Each conducting element is of square shape and each space separating two contiguous conducting elements has the same length. Each of the contiguous conducting elements are linked pairwise by a resistor 13. Each resistor of the device has the same resistance value.

This device can be used as support for a wire antenna so as to form an antenna device. In this use, the EBG device also has a reflector function in respect of the waves radiated toward said EBG device. A drawback of this antenna device is that the surface area covered by the array of conducting elements 12 is greater than that occupied by the radiating element rendering the antenna device bulky and more unwieldy, penalizing integration into a carrier.

FIG. 2 represents an exemplary embodiment of an electromagnetic band gap device 20 according to the invention. In this exemplary embodiment, the device comprises a dielectric support 24 of height h of which one face 21 is metallized to form a conducting plane acting as ground plane. The second face comprises a plurality of non-adjoining conducting elements 22. Certain contiguous conducting elements are linked pairwise by a resistive element 23 and others are not linked together by a resistive element 23 and are therefore electrically insulated. With respect to the structure presented in FIG. 1, the structure of the present invention forms a partially loaded electromagnetic band gap device. In certain embodiments, not all the resistors 23 have the same value thus at least two resistive elements 23 have different values of resistance. According to a variant embodiment, all the resistive elements have the same value.

In contradistinction to certain electromagnetic band gap devices of the prior art, the various conducting elements are not linked to the ground plane 21 by a via but are disposed floating with respect to said conducting plane 21.

The invention employs controlled fabrication techniques and implements technology of printed circuit type which allows good reproducibility of the performance of the electromagnetic band gap device. Thus, the substrate of the support of the device 20 may be a printed circuit board and the dielectric used may be epoxy. The conducting elements 22 and the ground plane 21 may be etched directly on the printed circuit board.

In an advantageous manner, the presence of resistive elements 23 makes it possible to limit or indeed remove the propagation of the surface currents along the conducting elements over a wide frequency band.

According to a particular embodiment, each of the contiguous conducting elements 22 are linked pairwise by a resistive element 23.

According to a particular feature of the invention, the conducting elements 22 may not all have the same geometric shape. Certain conducting elements may have a square shape, another a rectangular shape or any other possible geometric shape. Of course, the invention also encompasses the case where all the conducting elements have the same shape.

According to an embodiment, at least two conducting elements 22 have at least one different dimension (either widths, lengths or both).

As seen above, the conducting elements 22 of the electromagnetic band gap device are not adjoining. According to an embodiment, all the spaces between the conducting elements 22 are identical. According to a variant embodiment, not all the contiguous conducting elements are spaced apart by the same distance. Thus certain contiguous conducting elements are spaced apart by a distance d₁ and others of a distance d₂ with d₁ and d₂ different.

FIG. 3 illustrates an exemplary use of the electromagnetic band gap device 20 according to the invention. In this example, the device 20 is used in an antenna device in association with a radiating element 30.

In a general manner, the electromagnetic band gap device may be used in an antenna device comprising an assembly comprising one or more radiating elements 30. The radiating element or elements 30 are disposed opposite the face of the support of the electromagnetic band gap device 20 comprising the conducting elements 22. The assembly comprising the radiating element or elements 30 are insulated electrically from the electromagnetic band gap device. According to an exemplary embodiment, the conducting elements 22 are separated from the radiating element or elements 30 by a dielectric substrate. This substrate may, for example, be a printed circuit board and the radiating element be etched directly on a face of this board.

So as to feed the radiating element or elements 30, at least one hole in the dielectric substrate 24 and the ground plane 21 of the electromagnetic band gap device is made so as to pass the power feed wire or wires for the radiating element or radiating elements 30. In a similar manner, at least one hole is produced in the substrate separating the antenna 30 from the conducting elements 22 so as to pass the power feed wire or wires.

The assembly comprising the radiating element or elements 30 can comprise at least one planar wire antenna. All types of planar wire antennas may be implemented in the invention, whatever their polarization. The radiating element or elements may for example be overlaid antennas (patch antenna).

According to a particular embodiment, at least one of the dimensions of the surface area of the assembly comprising at least one radiating element 30 is greater than at least one of the dimensions of the surface area occupied by the plurality of conducting elements 22 of the electromagnetic band gap device 20. In the example illustrated in FIG. 3, the plurality of conducting elements 22 does not cover the whole of the surface area occupied by the antenna 30 in its length direction. Of course, the invention also covers the case where the surface area occupied by the plurality of conducting elements 22 is greater than that of the assembly comprising at least one radiating element 30.

According to an embodiment, the projection in the plane containing the plurality of conducting elements 22 of at least one radiating element 30 exceeds the surface area occupied by the entirety of the conducting elements 22 of the electromagnetic band gap device 20.

In an advantageous manner, the decrease in the surface area occupied by the conducting elements 22 makes it possible to decrease the bulk and the mass of the dielectric material supporting the conducting elements 22. This decrease also makes it possible to improve the radiated electromagnetic performance of the antenna over a wide band of frequencies with respect to a conventional electromagnetic band gap structure loaded by resistors. This performance may be obtained over a band of frequencies of greater than an octave and possibly as much as a decade, depending on the band of frequencies considered.

With reference to FIG. 4 a method for determining the various parameters of an antenna device according to the invention is presented.

It is known that the phase difference between the incident electromagnetic wave and that reflected at the level of the surface of an electromagnetic band gap device, as a function of frequency, determines the operating span of this device. That is to say the frequency band over which the aft radiation, reflected on the electromagnetic band gap device, is in phase with the fore radiation. By convention the frequency span considered or band gap, is defined when the phase of the reflection coefficient varies between +90° and −90°.

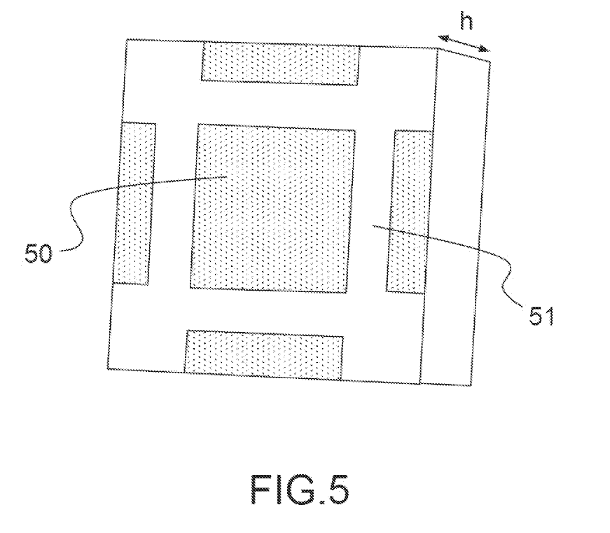

The various parameters of the electromagnetic band gap device are determined by numerical modeling. The shape of an elementary pattern 50 intended to form the conducting elements of the electromagnetic band gap device is chosen. By way of example, FIG. 5 illustrates a case in which an elementary pattern 50 of square shape placed on a substrate 51 of height h has been chosen. The reflected wave procedure, implemented by electromagnetic simulation software, thereafter makes it possible to refine the dimensions of the elementary pattern 50 and the distance separating each elementary pattern 50. This procedure, implemented in the course of a step 41 of determining the parameters of the elementary pattern, also makes it possible to choose the dielectric substrate and to fix its thickness h. The principle consists in illuminating an elementary pattern 50, periodized by boundary conditions, by a plane wave with normal incidence. The dimensions of the elementary pattern 50 are, if necessary, optimized until a band gap is obtained which is centered on the operating frequency span of the antenna device desired.

Once the dimensions of the elementary pattern 50 have been determined, this pattern is used to form an electromagnetic band gap device as presented in FIG. 1. An electromagnetic band gap device formed by an array of non-adjoining identical conducting elements having the same characteristics as the determined elementary pattern is therefore considered. This array is placed on one of the faces of a dielectric substrate whose nature and height have been determined by the above procedure. The second face of the dielectric substrate is entirely metallized so as to form a ground plane. Each of the contiguous conducting elements are spaced apart by an identical distance which is determined in the course of the previous step.

Such a structure, associated with the radiating element considered is thereafter simulated in the course of a simulation step 42. For this simulation, the value of the resistive element is chosen, for example, equal to the impedance in vacuo namely 377 Ohms.

An optimization of the bulk and of the mass of the electromagnetic band gap device as well as of the radiated performance of the associated antenna is carried out in the course of a step 43 of optimizing the electromagnetic band gap device. This optimization work pertains to the array of elementary patterns 50 placed under the radiating element. The objective is to decrease the surface area occupied by the array while optimizing the radiated performance of the antenna device produced. For example, the elementary patterns 50 placed on the exterior ring of the electromagnetic band gap device may be removed.

When the array comprises fewer elementary patterns 50, a new step 44 of optimizing the conducting elementary patterns is carried out. During this step, the dimensions of the elementary patterns 50 are modified so as to optimize the radiated performance of the antenna device produced. According to a wholly non-limiting example, increasing one of the sides of the square elementary patterns 50 situated at the two ends of the electromagnetic band gap device may improve the gain on the axis of the antenna. At the end of this step each elementary pattern 50 has been optimized to form the conducting elements 22 of the final electromagnetic band gap device 20.

To terminate production, a study of the influence of the value of the resistive elements 23 as well as their position is carried out in the course of a step of optimizing the resistive elements 45. For example, in the case of an antenna 30 formed by a radiating element of dipole type, the absence of resistive elements 23 in the principal planes of the antenna 30 makes it possible to considerably improve the half-power aperture and makes it possible to decrease the level of the sidelobes of the antenna device.

1. An electromagnetic band gap device, comprising:
a dielectric support comprising a first face that is metallized and a second face comprising a plurality of non-adjoining conducting elements, several of the conducting elements being linked together pairwise by a resistive element, wherein:
at least two of the conducting elements are electrically insulated from one another,
at least two resistive elements have different resistance values, and
at least two contiguous conducting elements are spaced apart by a distance d1 and at least another two contiguous conducting elements are spaced apart by a distance d2, the distances d1 and d2 being different.

2. The electromagnetic band gap device of claim 1, wherein the at least two of the conducting elements exhibit different shapes.

3. The electromagnetic band gap device of claim 1, wherein the at least two of the conducting elements occupy different surface areas.

4. The electromagnetic band gap device of claim 1, wherein at least one conducting element has a square shape.

5. The electromagnetic band gap device of claim 1, wherein at least one conducting element has a rectangular shape.

6. Use of the electromagnetic band gap device of claim 1 in an antenna device, wherein the antenna device comprises an assembly comprising,
at least one radiating element disposed opposite the second face of the dielectric support of the electromagnetic band gap device that comprises the conducting elements; and
at least one radiating element electrically insulated from said electromagnetic band gap device.

7. The use of the electromagnetic band gap device of claim 6, wherein the assembly further comprises at least one radiating element comprising at least one planar wire antenna.

8. The use of the electromagnetic band gap device of claim 6, wherein the assembly further comprises at least one radiating element separated from the conducting elements by a dielectric substrate.

9. The use of the electromagnetic band gap device of claim 6, wherein a projection in a plane comprising the plurality of conducting elements of at least one radiating element exceeds the surface area occupied by an entirety of the conducting elements of the electromagnetic band gap device.

10. A method for determining parameters of the electromagnetic band gap device of claim 1, the method comprising:
determining parameters of an elementary pattern;
simulating an electromagnetic band gap device produced based on the elementary pattern;
the electromagnetic band gap device;
optimizing the elementary pattern; and
optimizing the resistive elements.
